(19) United States
(12) Patent Application Publication
(10) Pub. No.: US 2010/0208019 A1
(43) Pub. Date: Aug. 19, 2010

(54) METHOD FOR PRINTING A CLADDING PANEL

(75) Inventor: Jochen Schniepp, Freilassing (DE)

Correspondence Address: GREENBLUM & BERNSTEIN, P.L.C., 1950 ROLAND CLARKE PLACE, RESTON, VA, 20191, US

(73) Assignee: KAINDL FLOORING GMBH, Wals (AT)

(21) Appl. No.: 12/602,377

(22) PCT Filed: Jun. 10, 2009
(86) PCT No.: PCT/EP09/57209

§ 371 Date: Nov. 30, 2009

(30) Foreign Application Priority Data
Jun. 12, 2008 (DE) 10 2008 028 000.3

(51) Int. Cl. B41J 2/01

(52) U.S. Cl. 347/101

(57) ABSTRACT

The invention relates to a method for the contactless printing of a visible surface (10b) of a cladding panel (10) with a first predetermined pattern and at least one visible section (24a, 26a) of the surface of coupling means (24, 26), which are used to connect two panels (10) of this type, with a second predetermined pattern. According to the invention the first and second predetermined patterns are printed on the panel (10) in a contactless manner in a common printing operation, wherein the different spacing (H1, H2, H3) of the visible surface (10b) and of the at least one visible section (24a, 26a) from the printing unit (36) is taken into consideration by means of an adjustment, taking into account this spacing (H1, H2, H3), of the control signals fed to the printing unit (36) for the control thereof.

The invention relates to a method for printing a cladding panel, in particular a cladding panel for cladding a substrate, for example, a floor, wherein the cladding panel comprises:
A contact surface designated for installation on the substrate and a visible surface facing away from the contact surface,
Two pairs of side edges lying opposite one another, at least one of which is provided with coupling means for connecting two panels embodied identically with respect to the coupling means,
   wherein at least one visible section of the surface of the coupling means has a face normal that comprises a component that faces in the same direction as the face normal of the visible surface and
   wherein this at least one visible section is arranged between the visible surface and the contact surface, seen in the vertical direction of the panel,
   wherein, in the method
The cladding panel for printing is guided through under a printing unit, wherein the visible surface is printed in a contactless manner with a first predetermined pattern and
At least a part of the visible section of the surface of the coupling means is printed with a second predetermined pattern.

Although when a plurality of cladding panels of this type are connected to one another only the visible surface of the panels can still be seen, but not those surface sections of the coupling means which the unlaid panel presents to the viewer from the same direction from which he can also see the visible surface, i.e., those surface sections, the face normal of which has a component that faces in the same direction as the face normal of the visible surface. However, recently the trend has been to provide additional information on these surface sections, for example, the name or the logo of the manufacturer. This additional information is applied to the coupling means in a process step independent of the application of the first predetermined pattern onto the visible surface of the panel, for example, after a decorative paper has been compressed with the core material of the panel and the coupling means have been formed by milling.

The use of contactless printing methods is basically known from the prior art. Reference is made to the generally known inkjet printing method by way of example, in which a printing unit operating in a contactless manner, i.e., a printing unit that does not come into contact with the surface to be printed, emits a printing medium, for example, ink, by means of a plurality of printing elements in the direction of the surface to be printed.

Based on the prior art described above, the object of the present invention is to simplify the method disclosed at the outset.

This object is attained according to the invention through a method of the type mentioned at the outset, in which the first predetermined pattern and the second predetermined pattern are printed onto the cladding panel in a contactless manner in a common printing operation, wherein the different spacing of the visible surface and the at least one part of the visible section of the surface of the coupling means from the printing unit is taken into consideration by means of a creation, taking into account the respective spacing, of the control signals fed to the printing unit for the control thereof.

Because the second predetermined pattern is also printed on the panel in a contactless manner, both, of the patterns can be printed on the panel in one and the same operation. In order to thereby avoid that the fact that the surface of the panel to be printed with the first predetermined pattern has a different spacing from the printing unit than the surface of the panel to be printed with the second predetermined pattern, leads to a distortion of the overall pattern formed by the first predetermined pattern and the second predetermined pattern, the control signals fed to the printing unit for the control thereof can be generated in a manner that takes into account the respective spacing.

It is proposed according to a first possibility that the printing unit emits the printing medium for printing the first predetermined pattern and the printing medium for printing the second predetermined pattern with a different time control. This different time control can either be provided to the printing unit externally, for example, by a control unit controlling the printing unit (decentralized intelligence) or it can be generated by the printing unit itself (central intelligence). As a rule, it holds true that the printing unit must emit the printing medium sooner, the greater the spacing of the surface to be printed from the printing unit. Another parameter that should be taken into consideration in the creation of the time control of the printing unit is the feed rate with which the panel moves past the printing unit. The greater this feed rate, the sooner the printing unit must emit the printing medium. Preferably, the panel moves past the printing unit at a constant feed rate in a purely linear movement.

Additionally or alternatively to the first possibility, however, it is also possible to provide the overall pattern fed to the printing unit with a counter-distortion of the first predetermined pattern and of the second predetermined pattern, which counter-distortion is embodied such that it compensates for the distortion during printing, so that as a whole the desired overall pattern is produced. If in this case a firmly stipulated counter-distortion is used, the panel must be moved past the printing unit at a feed rate corresponding to this counter-distortion.

As already mentioned above, in the creation of the control signals fed to the printing unit for the control thereof, at least one further parameter, for example, the feed rate at which the panel is moved past the printing unit, can be taken into account.

In order to be able to impart the simplest possible structural design to the device for carrying out the method according to the invention, it is proposed in a further development of the invention that during the printing operation the printing unit should retain a consistent relative position with respect to the panel to be printed, is preferably arranged in a stationary manner.

In principle, all of the coupling means of the panel can be printed by means of the method according to the invention, i.e., those coupling means that are assigned to the leading and trailing side edges in the direction of movement of the panel, as well as those coupling means that are assigned to the two lateral side edges in the direction of movement of the panel. In the case of the coupling means that are assigned to the trailing side edge in the direction of movement of the panel, however, the problem of a “shadowing” of at least one section of the surface of these coupling means can occur through the trailing side edge in the direction of movement of the panel. In order to be able to also render possible the most complete printing possible of the coupling means assigned to this side edge on the trailing side edge in the direction of movement of the panel, in a further development of the invention it is therefore proposed that the printing unit is attached such that it gives to the print medium leaving it, a speed component that points in the direction of the movement of the panel relative to the printing unit during the printing operation. In this manner the relative speed between the print medium and the panel in the direction of movement of the panel can at least be reduced, if not even brought completely to zero or even over-compensated. In this manner, a section, “shadowed” by the trailing side edge of the panel, of the surface of the coupling means assigned to this side edge can at least be reduced if not eliminated completely.

It should also be added that although the visible surface in principle runs essentially in one plane, it can nevertheless be contoured by indentations and/or elevations, for example, in order to give the panel a surface structure that corresponds optically and/or in terms of touch to the first predetermined pattern. For example, the grain of a predetermined type of wood or the surface structure of tiles including the joints provided between them can be imitated hereby.

The panel can comprise a core, which is provided with a decorative layer having the visible surface and a counteracting layer having the contact surface. The core can be formed, for example, by an MDF board and/or an HDF board and/or an OSB board and/or a chipboard and/or a plywood board and/or a multiplex board. The decorative layer can be formed, for example, by a laminate comprising at least one paper ply and/or a veneer and/or a layer comprising cork and/or at least one textile and/or at least one plastic and/or at least one mineral and/or can be linoleum and/or natural rubber and/or vulcanized rubber, wherein the visible surface in each case is embodied in a printable manner. The counteracting layer can likewise be embodied as a single-ply or multiple-ply synthetic resin-impregnated paper layer and/or as a layer comprising a veneer and/or cork and/or at least one textile and/or at least one plastic and/or at least one mineral and/or of linoleum and/or of natural rubber and/or of vulcanized rubber.

Furthermore, it should be added that with the aid of the method according to the invention not only can the panels be printed with second predetermined patterns, which are independent of the first predetermined pattern, but it is also possible to have the first predetermined pattern and the second predetermined pattern merge into one another. In this manner it is also possible, for example, to print a wood structure onto the coupling means, so that the panel overall has the appearance of a solid wood panel.

The invention is explained in more detail below based on the attached drawing. It shows:

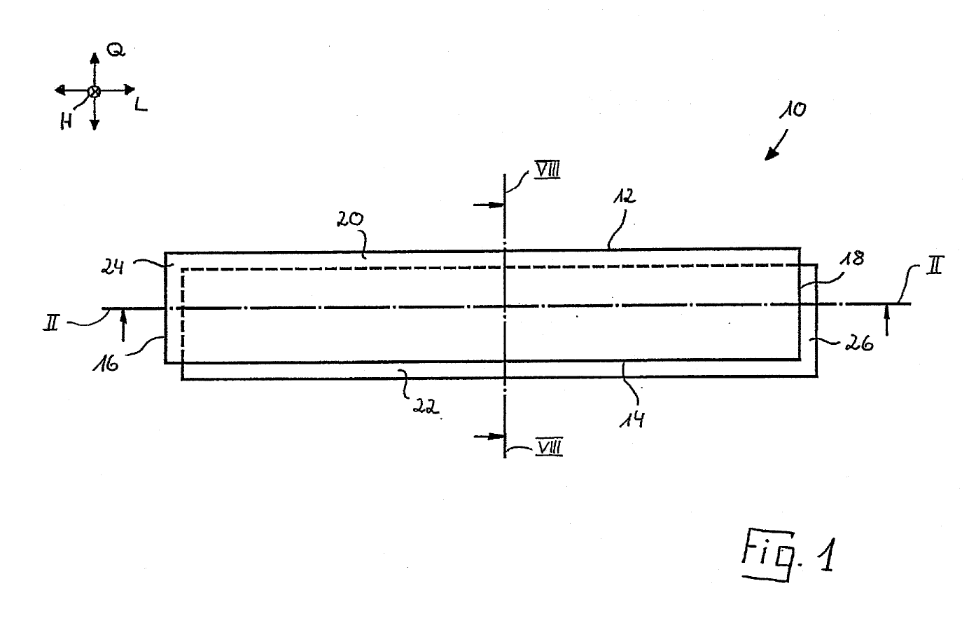

FIG. 1A rough diagrammatic plan view of a cladding panel;

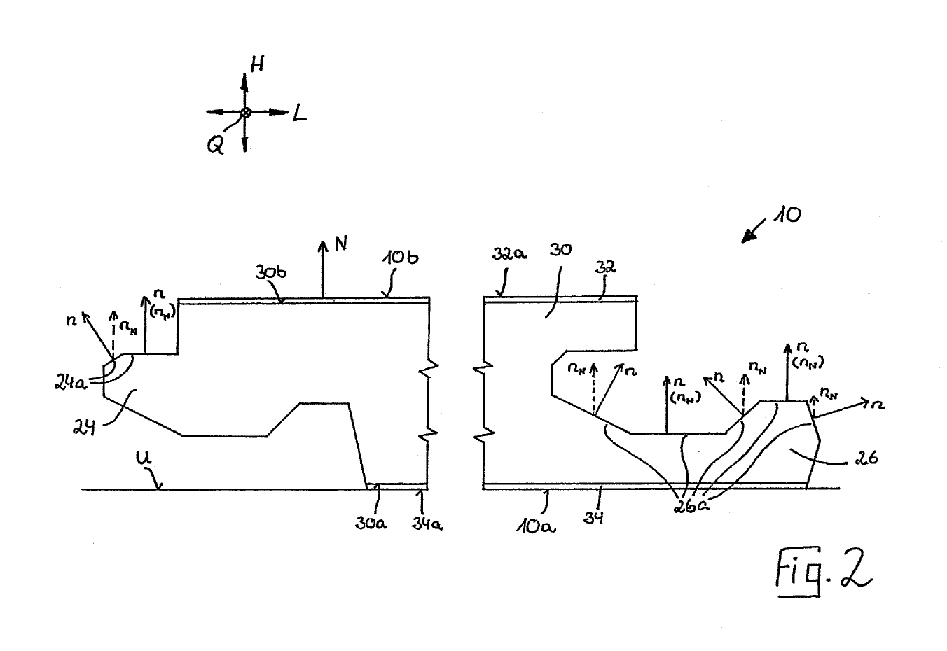

FIG. 2 A sectional view taken along the line II-II in FIG. 1 of an exemplary embodiment of the cladding panel;

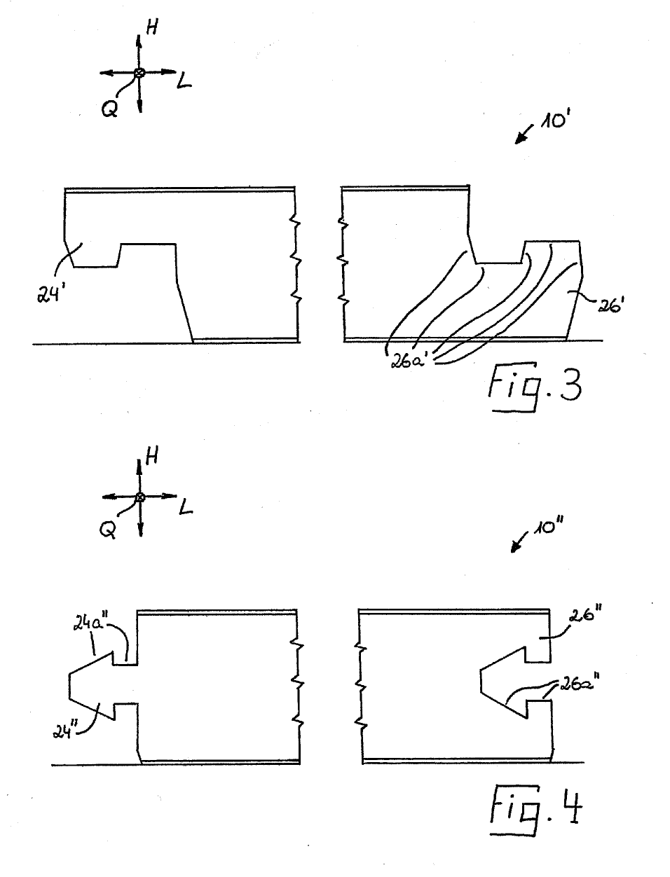

FIGS. 3 and 4 Views similar to FIG. 2 of cladding panels of alternative embodiments;

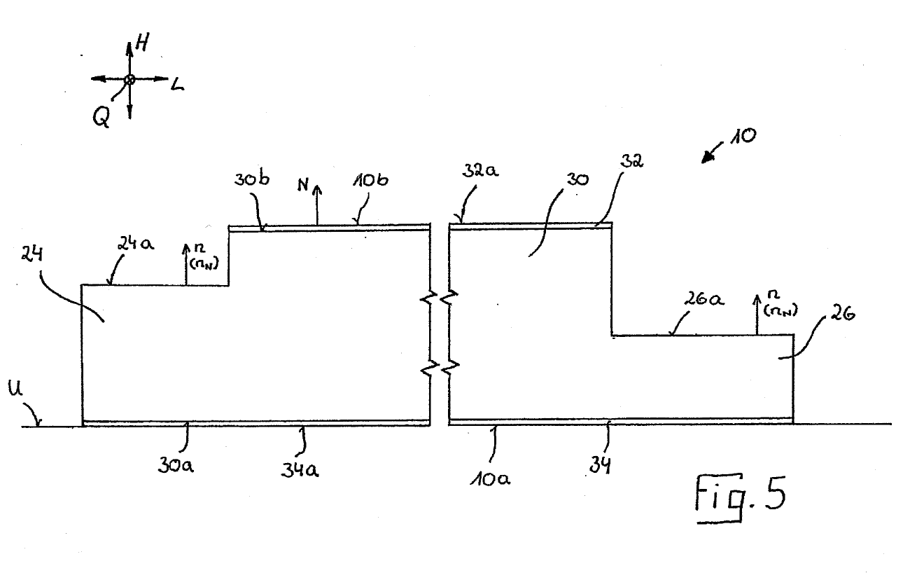

FIG. 5 A view similar to FIG. 2, which represents a rough diagrammatic simplification of the cladding panel;

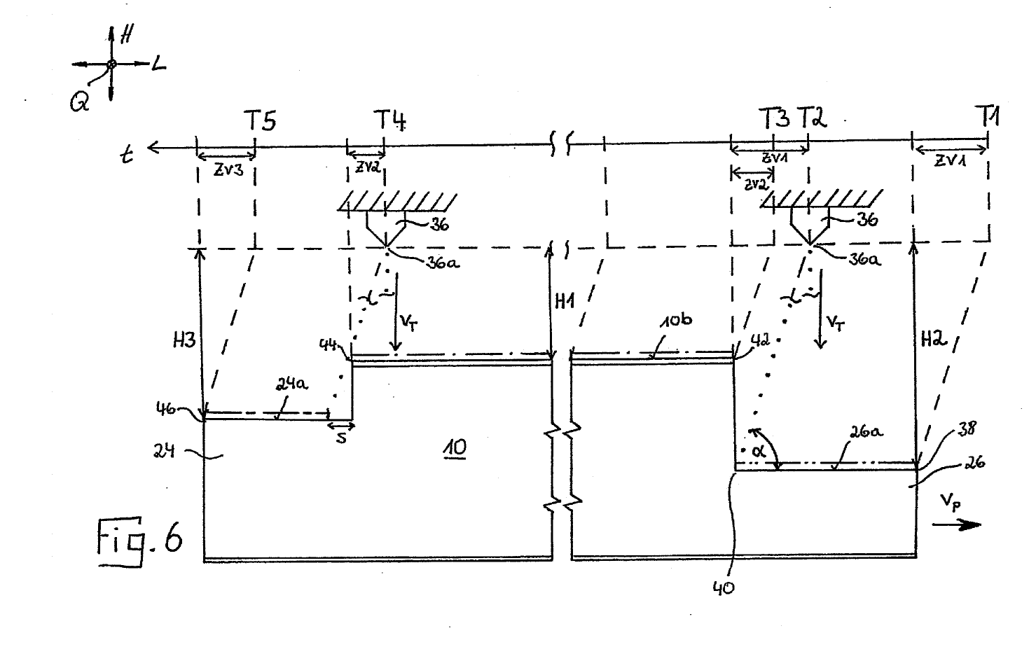

FIG. 6 A view similar to FIG. 5 to explain the method according to the invention;

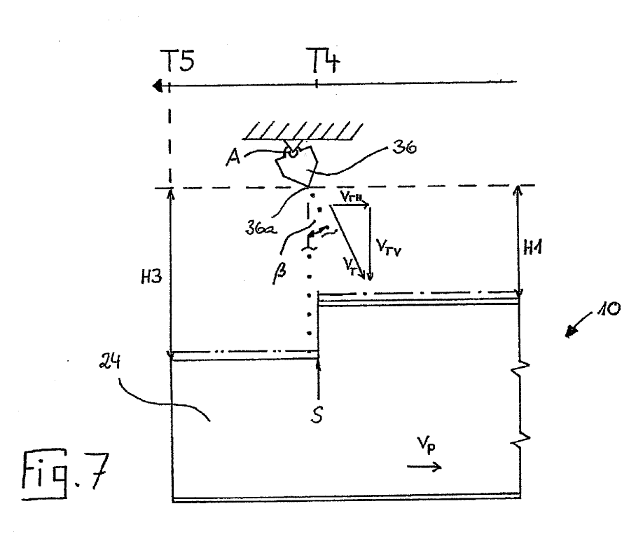

FIG. 7 A view similar to FIG. 6, but wherein only the trailing coupling means is shown, to explain a modified embodiment of the method according to the invention; and

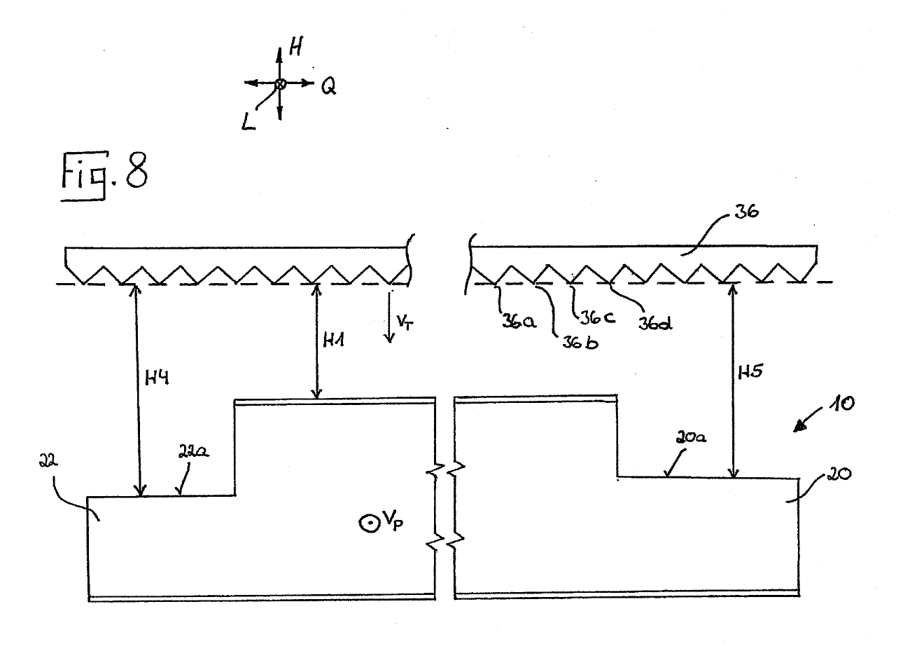

FIG. 8 A rough diagrammatic sectional view of the cladding panel taken along the line VIII-VIII in FIG. 1 during the printing operation;

In FIG. 1, 10 is used to label a cladding panel in general. The panel 10 is embodied in a rectangular manner and comprises two side edges 12 and 14 running parallel to one another of the longitudinal sides of the panel 10 running in the longitudinal direction L, as well as two side edges 16 and 18 running parallel to one another of the short sides of the panel 10 running in the transverse direction Q. Both pairs 12/14 and 16/18 of side edges are provided with coupling means 20 and 22 and 24 and 26 respectively.

FIG. 2 shows a sectional view of the cladding panel 10 taken along the line II-II in FIG. 1. As can be seen in FIG. 2, the coupling means 24 and 26 of the panel 10 can be embodied as so-called “angling” coupling means, which can be connected to one another by pivoting into one another about an axis running essentially parallel to the respective side edge. The panel 10 comprises a contact surface 10a designated for installation on the substrate U and a visible surface 10b facing away from the contact surface 10a. Furthermore, the panel 10 comprises a core 30, which is produced, for example, using wood fibers and/or wood chips and can be formed, for example, by an MDF board, an HDF board, an OSB board, a plywood board, a multiplex board, a chipboard or the like. On a surface 30b assigned to the visible surface lob, the core 30 is covered with a decorative layer 32, the surface 32a of which forms the visible surface 10b of the panel 10. In an analogous manner on a surface 30a assigned to the contact surface 10a the core 30 is covered with a counteracting layer 34, the surface 34a of which forms the contact surface 10a of the panel 10.

The decorative layer 32 can be formed, for example, by a laminate comprising at least one, preferably artificial resin-impregnated, paper ply and/or a veneer and/or can be a layer comprising cork and/or at least one textile and/or at least one plastic and/or at least one mineral and/or be formed of linoleum and/or of natural rubber and/or of vulcanized rubber. This counteracting layer 34 can likewise be embodied as a single-ply or multiple-ply paper layer impregnated with artificial resin and/or as a layer comprising a veneer and/or cork and/or at least one textile and/or at least one plastic and/or at least one mineral and/or comprise linoleum and/or natural rubber and/or vulcanized rubber. Furthermore, the decorative layer 32 can have contours which make the panel 10 appear more attractive visually or in terms of touch, for example, in that the natural grain of wood or stone is imitated. Despite this possible contouring, the decorative layer 32 can be considered as essentially flat and parallel to the counteracting layer 34. It is thus possible to assign a face normal N to the essentially flat extension running parallel to the visible surface 10b.

The panel 10 has on the surfaces of the coupling means 24, 26 at least one visible section 24a, 26a, which is characterized in that its face normal n comprises a component n_{N} which faces in the same direction as the face normal N of the visible surface 10b. The term “direction” should hereby be understood to mean a unidirectional direction (in FIG. 2 upwards). Furthermore, it should be noted that a “visible section” according to the understanding of the term defined above does not necessarily have to be actually visible to an observer.

FIGS. 3 and 4 show two further exemplary embodiments of cladding panels 10′ (FIG. 3) and 10″ (FIG. 4) respectively, which are embodied with a different type of coupling means 24′, 26′ (FIG. 3) and 24″, 26″ (FIG. 4) respectively. In particular, the coupling means 24′, 26′ according to FIG. 3 are embodied as “fold down” coupling means, i.e., as coupling means that can be connected by means of simple insertion into one another in a direction H (see FIG. 1) running essentially orthogonally to the panel plane. While the coupling means 26′ has several visible sections 26a′ according to the meaning of the term defined above, the coupling means 24′ does not have any visible sections of this type. The coupling means 24″, 26″ according to FIG. 4 are embodied as “snap” coupling means, i.e., as coupling means that can be connected by pushing them into one another in an essentially planar manner and engaging them. Both of the coupling means 24″, 26″ have visible sections 24a″, 26a″, wherein the visible sections 26a″ are not completely visible to the viewer.

The coupling means 20, 22, not shown in FIGS. 2 through 4, on the longitudinal sides 12, 14 of the panel 10 can likewise be embodied as coupling means of the “angling” type, the “fold down” type or the “snap” type, wherein the coupling means 20, 22 on the longitudinal sides 12, 14 and the coupling means 24, 26 on the short sides 16, 18 of the panel 10 do not necessarily have to be embodied identically to one another. Although panels are known in which the longitudinal sides 12, 14 as well as the short sides 16, 18 are provided with coupling means of the “angling” type or the “snap” type, panels are also known in which although the longitudinal sides 12, 14 are provided with coupling means of the “angling” type or the “snap” type, the short sides 16, 18 are provided with coupling means of the “fold down” type. However, the decisive factor is that a plurality of panels embodied identically in terms of the coupling means can form a stable cladding of a substrate U.

FIG. 5 shows a view of the panel 10 similar to FIG. 2, wherein, however, the coupling means 24, 26 are shown only in a rough diagrammatic manner, i.e., with very simplified profile geometry. In particular both coupling means 24, 26 have in each case only one single visible section 24a, 26a, the face normal n of which moreover runs parallel to the face normal N of the visible surface 10b of the panel 10. Although, as is easily appreciated, no coupling can be effected with the coupling means 24, 26 as they are shown in FIG. 5 as well as in the further FIGS. 6, 7 and 8, the simplified representation of these coupling means serves to better clarify the problem described at the outset and the solution according to the invention. However, the principle explained below can also be applied with more complex profile geometries, such as, for example, those shown in the exemplary embodiments of FIGS. 2, 3 and 4.

FIG. 6 shows the panel 10 in the simplified representation according to FIG. 5 as it is guided through at a constant speed v_{P} in a linear manner in the longitudinal direction L of the panel 10 under a printing unit 36 operating in a contactless manner, which, for example, can be an inkjet printing unit. It has proven to be advantageous in practice to guide the panel 10 lying flat in the horizontal plane, while the printing unit 36 is arranged above this horizontal plane and generally running parallel thereto (cf. FIG. 8). The printing unit 36 is thereby mounted in a stationary manner to a fixed frame and has a plurality of printing nozzles (cf. FIG. 8) of which only one printing nozzle 36a is shown in FIG. 6 by way of example.

Furthermore, in FIG. 6 a timeline t (pointing to the left) is shown. On this time line, various points in time T1 through T5 are plotted, to which reference will be made in the course of the following discussion. The relative position of the printing unit 36 relative to the panel 10 is thereby plotted for two points in time T2, T4 of the printing operation.

While the panel 10 is guided through under it, the printing unit 36 first prints the visible section 26a of the coupling means 26 with a pattern indicated by a dash dot dot line, then the visible surface 10b of the panel 10 is printed with a pattern indicated by a dash dot line and subsequently the visible section 24a of the coupling means 24 is printed with a pattern indicated by a long dash/short dash line. During the printing operation, drops of ink leave the printing nozzles 36a of the printing unit 36 (in a stationary frame of reference with respect to the printing unit 36) at a constant speed v_{T} in a direction that runs perpendicular to the horizontal plane in which the panel is guided in a linear manner. However, seen from the panel 10, i.e., in a stationary frame of reference with respect to the panel 10, the drops of ink do not strike the visible section 26a or the visible surface 10b or the visible section 24a orthogonally, but at an angle α, which is less than 90°. This angle α depends decisively on the ratio between the speed v_{T} of the ink, which is determined by the design of the printing unit 36, and the speed v_{P} of the panel 10, which can be adjusted if necessary.

In order to print the visible section 26a of the coupling means 26, the printing unit starts the printing operation at a point in time T1, i.e., with a time advance ZV1 with respect to the outermost side edge 38 of the coupling means 26, which is not yet located vertically under the printing nozzles 36a of the printing unit 36 at the point in time T1. The size of this time advance ZV1 depends on the angle α and the spacing H2 between the visible section 26a and the printing nozzle 36a. The printing unit 36 ends the printing operation for printing the visible section 26a at a point in time T2, wherein the point in time T2 has the time advance ZV1 already referenced above with respect to the edge 40.

Since the visible surface 10b, to be printed subsequently, of the panel 10 has a smaller distance H1 from the printing nozzle 36a than the visible section 26a, just printed, of the coupling means 26, the time advance ZV2 for the printing of the visible section 10b, which begins on the edge 42, is smaller than the time advance ZV1. Consequently, the printing of the visible section 10b does not need to start until point in time T3. An interval thus occurs. This interval can optionally be used to also print the vertical flank between the visible section 26a and the visible section 10b.

The entire visible surface 10b of the panel 10 is then printed at a point in time T4, wherein the point in time T4 has the time advance ZV2 already cited above with respect to the edge 44 at which the visible surface 10b ends. Directly thereafter the printing unit 36 starts to print the visible section 24a of the coupling means 24, and continues this printing operation until the edge 46, at which the visible section 24a ends, has been reached at a point in time T5. The point in time T5 thereby has a time advance ZV3 with respect to the edge 46.

Since the visible section 24a has a distance H3 to the printing nozzle 36a, which is greater than the distance H1, the time advance ZV3, which can be assigned to the visible section 24a, is also greater than the time advance ZV2. The printing of the visible section 24a would therefore have to be started at a time at which the printing of the visible surface 10b has not yet been completed. Of course, this is impossible. With the trailing coupling means with the embodiment shown in FIG. 6 the development of a “shadowed” section S on the visible section 24a of the coupling means 24 therefore cannot be avoided.

The size of the shadowed section S thereby depends, in addition to the angle α, decisively on the difference between the spacing H1 (spacing between visible surface 10b and printing nozzle 36a) and the spacing H3 (spacing between visible section 24a and printing nozzle 36a). The greater the difference between spacing H1 and spacing H3, the larger the shadowed area S. In order to keep the shadowed area S as small as possible, it is therefore recommended to ensure while guiding the panel 10 under the printing unit 36 that coupling means 24, 26, the visible section 24a, 26a of which has the smaller spacing H3, H2 from the printing nozzle 36a, is selected as the trailing coupling means and the respectively other coupling means is selected as the leading coupling means. For this reason (H2>H3) according to FIG. 6 the coupling means 26 was selected as the leading coupling means and the coupling means 24 was selected as the trailing coupling means.

On the basis of analogous considerations, in the case of the “angling” coupling means according to FIG. 2 the coupling means 26 would therefore be selected as the leading coupling means and the coupling means 24 would be selected as the trailing coupling means.

As can be seen in FIG. 7, in which only the trailing end 24 is shown, it can be achieved through a simple modification of the arrangement of the printing unit 36 that the shadowed section S is reduced in size and possibly even disappears completely. It should be noted with regard to the representation according to FIG. 7 that in this case the section S has a vanishing width, as indicated by the arrow S. In the referenced modification, the printing unit 36 is aligned such that the ink is no longer emitted in a direction precisely orthogonal to the horizontal plane in which the panel 10 is guided during printing, but in a direction deviating therefrom by the angle β, i.e., a direction that has a component in the direction of movement of the panel 10. Depending on how far the printing unit 36 is swiveled about an axis A (see FIG. 7), the relative speed between the ink and the panel 10 in the direction of movement of the panel 10 can be reduced, brought completely to zero or even over-compensated. An overcompensation can be useful when the trailing coupling means has visible sections that are located in undercuts, but which are nevertheless to be printed.

FIG. 7 shows an arrangement of the printing unit 36, in which the printing unit 36 is swiveled about the axis A precisely to the extent that when the speed v_{T} of the ink is vectorially broken down into a horizontal speed component v_{TH} and a vertical speed component v_{TV}, the amount and the direction of the horizontal speed component v_{TH} are identical to the amount and the direction of the speed v_{P} of the panel. As a result there is no longer any shadowed section S, since the ink strikes the panel in a stationary frame of reference with respect to the panel exactly orthogonally to the panel plane, namely at a speed v_{TV}. Furthermore, the time advances ZV1, ZV2 and ZV3 are reduced to zero.

As already mentioned above, the printing unit 36 comprises a plurality of printing nozzles 36a, 36b, 36c, 36d, etc. FIG. 8 is a rough diagrammatic representation (with simplified profile geometry already known from FIG. 5), which shows how panel 10 can be printed on its entire width running in the transverse direction Q simultaneously by printing nozzles 36a, 36b, 36c, 36d etc., when it is guided through under the printing unit 36. During the printing of the coupling means 20, 22 on the respective side edges 12, 14 of the longitudinal sides of the panel 10 running in the longitudinal direction L, the spacings H4 or H5 between the respective visible sections 22a, 20a of the coupling means 22, 20 and the printing nozzles of the printing unit 36 located above these visible sections 22a, 20a are thereby to be taken into consideration.

The parameters discussed and explained above, namely
The spacings H1-H5 between the visible sections 20a, 22a, 24a, 26a to be printed of the coupling means 20, 22, 24, 26 or the visible surface 10b of the panel 10 and the printing nozzles 36a, 36b, 36c, 36d, etc.,
The speed v_{T} of the ink when leaving the printing unit 36,
The speed vₚ of the panel while it is guided through in a linear manner under the printing unit 36, and
Optionally the swiveling angle of the printing unit 36 about the axis A are all fed to a control unit (not shown), which is connected to the printing unit 36. On the basis of these parameters the control unit activates the individual printing nozzles 36a, 36b, 36c, 36d of the printing unit 36 so precisely in terms of time that the visible surface 10b of the panel 10 and the visible sections 20a, 22a, 24a, 26a of the coupling means 20, 22, 24, 26 are printed with the respectively desired patterns. The calculation of the activation data can be carried out thereby either with the corresponding processing power of the control unit in real time, wherein it is possible, for example, to measure some of the above-mentioned parameters in real time during the printing operation, or it can take place in advance, provided that the parameters (e.g., the profile geometry of the panel to be printed) are already known in advance. Furthermore, it is also conceivable that the control unit is integrated into the printing unit 36.

As already explained above, the possible coupling means of the panel 10 have a profile geometry which as a rule is more complex than that described in FIG. 5 to better illustrate the method according to the invention. In particular, the various visible sections 20a, 22a, 24a, 26a of the coupling means 20, 22, 24, 26 do not all need to lie parallel to the upper visible surface 10b of the panel 10 (see, e.g., FIGS. 2, 3, 4), but instead can run obliquely thereto if the respective visible sections 20a, 22a, 24a, 26a are flat, or, if the visible sections 20a, 22a, 24a, 26a are curved, they can have at least one radius of curvature. In such cases the respective visible sections 20a, 22a, 24a, 26a can be viewed in an approximation which is carried out advantageously by the control unit as a plurality of smaller visible sections, which are oriented approximately parallel to the visible surface 10b of the panel 10 and which thus have a precisely defined spacing from the corresponding printing nozzles by which the section is to be printed. The resolution of this subdivision is thereby oriented preferably to the resolution of the printing unit 36.

Furthermore, it should be noted that the printing of the visible sections 20a, 22a, 24a, 26a fundamentally has certain limits, depending on the geometry. This applies in particular to visible sections 20a, 22a, 24a, 26a, which are located partially or completely in undercuts, so that ink from the printing unit 36 can hardly reach them or cannot reach them at all (see e.g., the left visible section 26a of the “angling” profile in FIG. 2 or the visible section 26a″ of the “snap” profile in FIG. 4). In the case of the coupling means 24, 26 of the trailing or leading side edges 16, 18, the angle α described above or optionally a swivel angle β of the printing unit 36 about the axis A can be used in order to nevertheless print such visible sections 24a, 26a of this type within certain limits.

1. Method for printing a cladding panel (10), in particular a cladding panel (10) for cladding a substrate (U), for example, a floor, wherein the cladding panel (10) comprises:
A contact surface (10a) designated for installation on the substrate (U) and a visible surface (10b) facing away from the contact surface (10a),
Two pairs of side edges (16/18, 20/22) lying opposite one another, at least one of which is provided with coupling means (20, 22, 24, 26) for connecting two panels (10) embodied identically with respect to the coupling means (20, 22, 24, 26),
wherein at least one visible section (20a, 22a, 24a, 26a) of the surface of the coupling means (20, 22, 24, 26) has a face normal (n) that comprises a component (n_{N}) that faces in the same direction as the face normal (N) of the visible surface (10b) and
wherein this at least one visible section (20a, 22a, 24a, 26a) is arranged between the visible surface (10b) and the contact surface (10a), seen in the vertical direction (H) of the panel (10),
wherein, in the method
The cladding panel (10) for printing is guided through under a printing unit (36), wherein the visible surface (10b) is printed in a contactless manner with a first predetermined pattern and
At least a part of the visible section (20a, 22a, 24a, 26a) of the surface of the coupling means (20, 22, 24, 26) is printed with a second predetermined pattern,
characterized in that the first predetermined pattern and the second predetermined pattern are printed onto the cladding panel (10) in a contactless manner in a common printing operation, wherein the different spacing (H2, H3, H4, H5) of the visible surface and the at least one part of the visible section (20a, 22a, 24a, 26a) of the surface of the coupling means (20, 22, 24, 26) from the printing unit (36) is taken into consideration by means of an adjustment, taking into account the respective spacing (H2, H3, H4, H5), of the control signals fed to the printing unit (36) for the control thereof.

2. Method according to claim 1, characterized in that the printing unit (36) emits the printing medium for printing the first predetermined pattern and the printing medium for printing the second predetermined pattern with a different time control.

3. Method according to claim 1, characterized in that the overall pattern fed to the printing unit (36) is provided with a counter-distortion of the first predetermined pattern relative to the second predetermined pattern.

4. Method according to claim 1, characterized in that in the creation of the control signals fed to the printing unit (36) for the control thereof, at least one further parameter, for example, the feed rate (v_{T}) with which the panel (10) is moved past the printing unit (36), is taken into account.

5. Method according to claim 1, characterized in that during the printing operation the printing unit (36) retains a consistent relative position with respect to the panel (10) to be printed.

6. Method according to claim 1, characterized in that the printing unit (36) is attached such that it gives to the print medium leaving it, a speed component (v_{TH}) that points in the direction of the movement of the panel (10) relative to the printing unit (36) during the printing operation.

7. Method according to claim 1, characterized in that the contactless printing method is the inkjet printing method.
